(19) United States
(12) Patent Application Publication
(10) Pub. No.: US 2026/0111613 A1
(43) Pub. Date: Apr. 23, 2026

(54) DEVICE CONTROLLER AND METHOD OF OPERATING THE SAME, AND STORAGE SYSTEM

(71) Applicant: Samsung Electronics Co., Ltd., Suwon-si (KR)

(72) Inventor: Youngsik Moon, Suwon-si (KR)

(21) Appl. No.: 19/358,286

(22) Filed: Oct. 14, 2025

(30) Foreign Application Priority Data
Oct. 17, 2024 (KR) 1020240142311

(51) Int. Cl. G06F 21/72; G06F 21/31; G06F 21/79

(52) U.S. Cl. CPC G06F 21/72; G06F 21/31; G06F 21/79

(57) ABSTRACT

An example device controller includes an authentication value generation circuit and an authentication verification circuit. The authentication value generation circuit is configured to generate a plurality of authentication values based on a plurality of shared keys and transmit the plurality of authentication values to a plurality of storage devices. The authentication verification circuit is configured to identify and group, based on receiving an authentication command from a host, a plurality of target storage devices corresponding to the authentication command into a target storage group and verify authentication for the target storage group based on a plurality of authentication values of the plurality of target storage devices.

### CROSS-REFERENCE TO RELATED APPLICATION

This application claims priority under 35 U.S.C. § 119 to Korean Patent Application No. 10-2024-0142311, filed on Oct. 17, 2024, in the Korean Intellectual Property Office, the disclosure of which is incorporated by reference herein in its entirety.

### BACKGROUND

Recently, the interest in high-capacity storage systems is increasing as the development of technologies with high data usage progresses, such as artificial intelligence (AI). Generally, when receiving a device authentication request (e.g., authentication command) from a host, a storage device performs an individual authentication process for each storage device by configuring a 1:1 protocol between the host and the storage device. In the case of a high-capacity storage system including a plurality of storage devices, the authentication process may be delayed or the data overload in the system may be increased due to the repetitive authentication process for each storage device, resulting in deterioration of performance of the entire system.

### SUMMARY

The present disclosure relates to a device controller for efficiently performing device authentication in a high-capacity storage system including a plurality of storage devices, a method of operating the same, and a storage system.

The present disclosure is not limited to the mentioned above and other concepts may be clearly understood by those skilled in the art from the description below.

In some implementations, a device controller includes: an authentication value generation circuit configured to generate a plurality of authentication values based on a plurality of shared keys, and transmit the plurality of authentication values to a plurality of storage devices; and an authentication verification circuit configured to identify, based on receiving an authentication command from a host, a plurality of target storage devices corresponding to the authentication command, group the plurality of target storage devices into a target storage group, and verify authentication for the target storage group based on a plurality of authentication values of the plurality of target storage devices.

In some implementations, a method of operating a device controller includes: generating a plurality of authentication values based on a plurality of shared keys; transmitting the plurality of authentication values to a plurality of storage devices; based on receiving an authentication command from a host, identifying a plurality of target storage devices corresponding to the authentication command; grouping the plurality of target storage devices into a target storage group; verifying authentication for the target storage group based on a plurality of authentication values of the plurality of target storage devices received from the plurality of target storage devices; and transmitting an authentication result message for the target storage group to the host.

In some implementations, a storage system includes: generate a plurality of authentication values based on a plurality of shared keys between the device controller and the plurality of storage devices; distribute the plurality of authentication values to the plurality of storage devices, respectively; based on receiving an authentication command from the host, group a plurality of target storage devices into a target storage group, the plurality of target storage devices corresponding to the authentication command; receive a plurality of authentication values of the plurality of target storage devices from the plurality of target storage devices; verify authentication for the target storage group based on the plurality of authentication values of the plurality of target storage devices; and transmit an authentication result of the target storage group to the host, wherein the plurality of authentication values are generated based on the plurality of shared keys.

### BRIEF DESCRIPTION OF THE DRAWINGS

Implementations will be more clearly understood from the following detailed description taken in conjunction with the accompanying drawings.

FIG. 1 is a diagram illustrating an example of a device authentication operation in a storage box.

FIG. 2 is a diagram illustrating an example of a device authentication operation in a storage box.

FIG. 3 is a block diagram of an example of a storage system.

FIG. 4 is a block diagram of an example of a storage device.

FIG. 5 is a block diagram of an example of a storage box.

FIG. 6 is a diagram illustrating an example of an operation of a device controller.

FIG. 7 is a flowchart of an example of a device authentication method for each storage group.

FIG. 8 is a flowchart of an example of a device authentication method for each storage group.

FIG. 9 is a flowchart of an example of a device authentication method for each storage group.

### DETAILED DESCRIPTION

Hereinafter, implementations are described in detail with reference to the accompanying drawings. While the implementations are illustrated with reference to the drawings and the detailed description, it is not intended to limit the various implementations to any particular form. For example, it is obvious to those skilled in the art that the implementations are subject to various modifications.

A storage box may refer to a storage device set including a device controller and a plurality of storage devices (e.g., solid-state drive (SSD)).

A target storage group may refer to a storage group including all of a plurality of storage devices for which authentication has been requested by a host.

A sub-storage group may refer to a storage group including at least some of the plurality of storage devices for which authentication has been requested by the host.

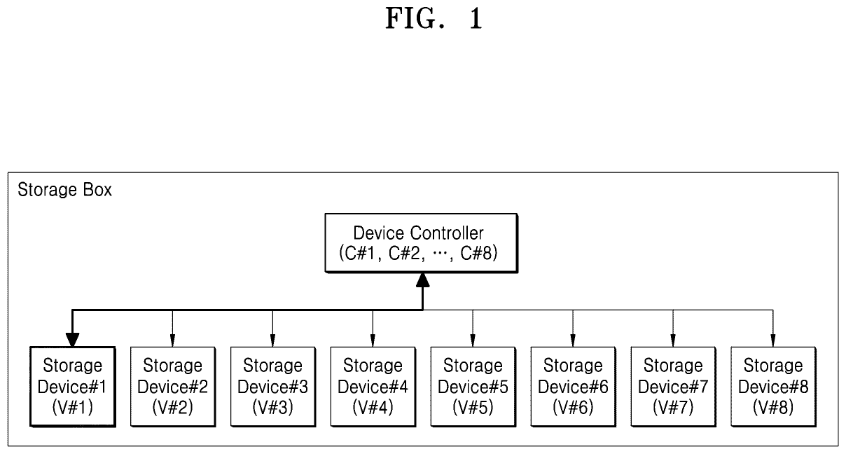

FIG. 1 is a diagram illustrating an example of a device authentication operation in a storage box.

Referring to FIG. 1, the storage box may include a device controller and a plurality of storage devices (e.g., a first storage device (Storage Device #1) to an eighth storage device (Storage Device #8)).

When receiving a command (hereinafter, referred to as an authentication command) requesting device authentication for the storage devices from a host, the storage box may perform the device authentication based on an authentication protocol for each storage device. The authentication protocol for each storage device (i.e., 1:1 protocol between a device controller and a storage device) may refer to a protocol that shares a key having a unique value between a device controller and a storage device and performs an authentication process (e.g., authentication request (Challenge)-response (Response)), based on the unique key of each storage device.

The device controller may generate an authentication request (Challenge) (hereinafter, referred to as C) (e.g., one of a first authentication request (C#1) and a second authentication request (C#2) to an eighth authentication request (C#8)) for a target storage device among currently operating storage devices and may transmit the authentication request to the target storage device when receiving an authentication command for the currently operating storage devices from the host. The target storage device that has received the authentication request (C) may transmit an authentication value (V) of the target storage device to the device controller in response to the authentication request (C). The device controller verifies authentication for the target storage device based on the authentication value (V) of the target storage device and repeatedly performs the aforementioned authentication process for the other currently operating storage devices.

For example, in FIG. 1, it is assumed that the first storage device (Storage Device #1) to the eighth storage device (Storage Device #8) are currently in operation. The device controller may transmit the first authentication request (C#1) to the first storage device (Storage Device #1) and may verify the authentication for the first storage device (Storage Device #1) based on a first authentication value (V #1) received from the first storage device (Storage Device #1) in response to the first authentication request (C#1). The device controller may also perform the same authentication process for the second storage device (Storage Device #2) to the eighth storage device (Storage Device #8) to perform the authentication for each of the second storage device (Storage Device #2) to the eighth storage device (Storage Device #8).

Therefore, as the device controller performs the authentication process for each storage device based on the authentication protocol for each storage device, the authentication process may be delayed or the data overload in the storage box may be increased due to the repetitive authentication process, resulting in deterioration of performance of the entire storage box.

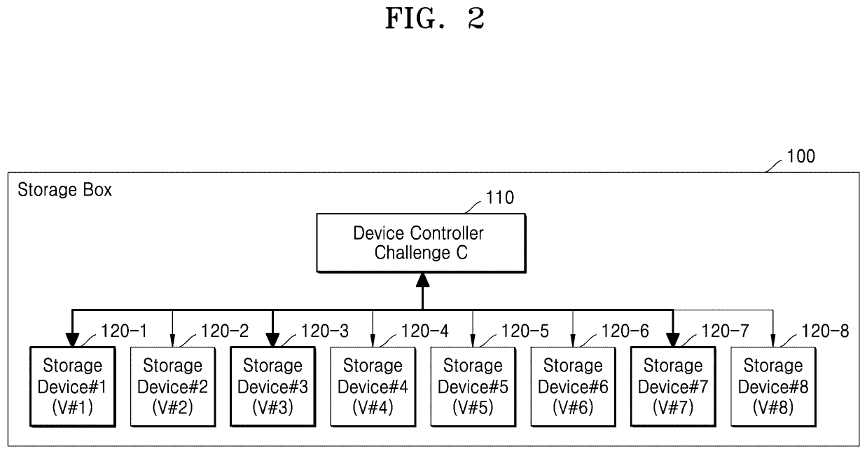

FIG. 2 is a diagram illustrating an example of a device authentication operation in a storage box.

Referring to FIG. 2, a storage box 100 may include a device controller 110 and a plurality of storage devices (e.g., a first storage device 120-1 (Storage Device #1) to an eighth storage device 120-8 (Storage Device #8)).

The storage box 100 may perform device authentication based on an authentication protocol for each storage group when receiving a command (hereinafter, referred to as an authentication command) requesting device authentication for the storage device from the host. The authentication protocol for each storage group (i.e., a 1:N protocol between a device controller and storage devices, where N is a positive integer) refers to a protocol that shares a key between the device controller 110 and a plurality of storage devices included in a storage group and performs an authentication process (e.g., authentication request (Challenge)-response (Response)) for each storage group based on the shared key. For example, the device controller 110 may generate authentication values of the plurality of storage devices in advance based on the shared key and may transmit/distribute the authentication values of the plurality of storage devices to the plurality of the storage devices, respectively. In the following authentication process, the device controller 110 may perform device authentication for each storage group based on the authentication values.

In some implementations, when receiving the authentication command for the currently operating storage devices from the host, the device controller 110 may identify and group target storage devices (i.e., currently operating storage devices) corresponding to the authentication command into a target storage group. The device controller 110 may transmit an authentication request (Challenge) (hereinafter, referred to as C) to the target storage devices in the target storage group. The target storage devices that received the authentication request (C) may transmit the authentication values of the target storage devices to the device controller 110 in response to the authentication request (C). The device controller 110 may verify authentication for the target storage group based on the authentication values of the target storage devices.

For example, in FIG. 1, it is assumed that the first storage device (Storage Device #1), the third storage device (Storage Device #3), and the seventh storage device (Storage Device #7) are currently in operation. The device controller 110 may identify the first storage device (Storage Device #1), the third storage device (Storage Device #3), and the seventh storage device (Storage Device #7) as target storage devices when receiving an authentication command for the currently operating storage devices from the host. The device controller 110 may group the first storage device (Storage Device #1), the third storage device (Storage Device #3), and the seventh storage device (Storage Device #7) into a target storage group. The device controller 110 may transmit the authentication request (C) to the first storage device (Storage Device #1), the third storage device (Storage Device #3), and the seventh storage device (Storage Device #7) in the target storage group. The device controller 110 may verify authentication for the target storage group based on the pre-stored shared key, the first authentication value (V #1) of the first storage device (Storage Device #1), the third authentication value (V #3) of the third storage device (Storage Device #3), and the seventh authentication value (V #7) of the seventh storage device (Storage Device #7).

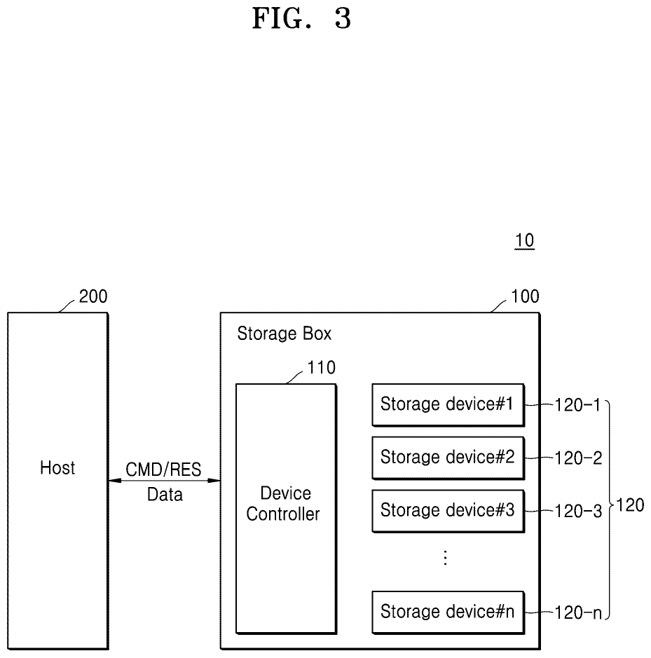

Thus, as the authentication is verified for each storage group, the storage controller 110 may simultaneously perform the authentication for the target storage devices included in the target storage group. Furthermore, the device controller 110 may not repeatedly perform the authentication process for each storage device, thereby preventing the authentication delay and data overload due to the repetitive authentication process. The detailed description thereof may be given below with reference to FIGS. 3 to 9.

FIG. 3 is a block diagram of an example of a storage system.

Referring to FIG. 3, a storage system 10 may include a storage box 100 and a host 200. The storage system 10 may include one of devices for storing data, such as a mobile phone, a smartphone, an MP3 player, a laptop computer, a desktop computer, a game machine, a TV, a tablet PC, or an in-vehicle infotainment system.

The host 200 may refer to a data processing device capable of processing data, such as a central processing unit (CPU), a processor, a microprocessor, or an application processor (AP). The host 200 may execute an operating system (OS) and/or various applications. In some implementations, the storage system 10 may be included in a mobile device and the host 200 may be implemented as an AP. In some implementations, the host 200 may be implemented as a system-on-a-chip (SoC), and thus, may be embedded in an electronic device.

The host 200 may communicate with the storage box 100 through various interfaces. For example, the storage box 100 and the host 200 may be connected to each other according to an interface protocol defined in the universal flash storage (UFS) standard. Accordingly, the storage box 100 may include a UFS device and the host 200 may include a UFS host. However, the present disclosure is not limited thereto. The storage box 100 and the host 200 may be connected to each other according to various standard interfaces.

The host 200 may control a data processing operation, e.g., a data reading operation or a data write operation, for the storage box 100. The host 200 may transmit data and a command (CMD) requesting the data processing operation for the storage box 100 to the storage box 100 and the storage box 100 may perform the data processing operation in response to the command (CMD) and transmit a response (RES) indicating the operation result to the host 200. The host 200 may transmit a command (CMD) related to the general operation of the storage box 100, such as a read command and a write command. The host 200 may also transmit a command (CMD) according to an authentication/security protocol of an interface with the storage box 100, such as an authentication command for providing an authentication/security function of the storage box 100. The storage box 100 may transmit data (Data), that is generated by performing the operation in response to the request from the host 200 or that is read from the storage device 120, to the host 200.

The host 200 may provide the authentication/security function for communication between the host 200 and the storage box 100. The host 200 may generate and provide the data and authentication command requesting authentication for the storage device 120 to the storage box 100 and may perform the operation for the security function based on the data and/or response (RES) provided from the storage box 100.

The storage box 100 may be manufactured as a storage device set including a device controller 110 and a plurality of storage devices 120 (e.g., a first storage device 120-1 to an n^{th} storage device 120-n) of various kinds according to a host interface for communication with the host 200.

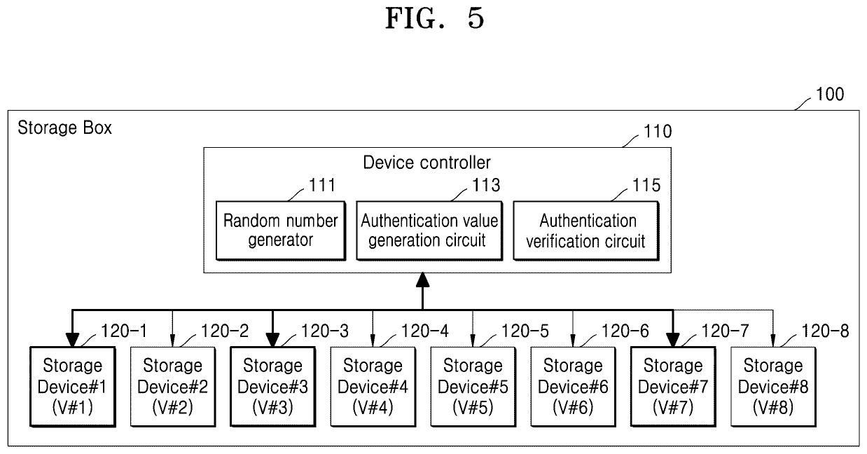

The device controller 110 may verify authentication for the plurality of storage devices 120 included in the storage box 100 on a storage group basis in response to the request from the host 200. For example, the device controller 110 may generate the authentication values of the plurality of storage devices 120 in advance based on the shared key generated with the unique value and may transmit/distribute the generated authentication values to the plurality of storage devices 120, respectively. When receiving an authentication command from the host 200 later, the device controller 110 may simultaneously verify authentication for target storage devices based on the shared key and the authentication values received from the target storage devices (i.e., the device controller 110 may verify authentication for the target storage devices on a storage group basis). The detailed description thereof may be given below with reference to FIGS. 5 to 9.

The device controller 110 may be connected to the plurality of storage devices 120 (e.g., the first storage device 120-1 to the n^{th} storage device 120-n) through a plurality of channels, respectively.

The storage device 120 may include various types of storage devices, such as an SSD, a multimedia card in the form of MMC, eMMC, RS-MMC, micro-MMC, a secure digital card in the form of SD, mini-SD, and micro-SD, a universal serial bus (USB) storage device, a universal flash storage (UFS) device, a storage device in the form of personal computer memory card international association (PCMCIA) card, a storage device in the form of peripheral component interconnection (PCI) card, a storage device in the form of PCI express (PCI-E), a compact flash (CF) card, a smart media card, and a memory stick. For example, each of the plurality of storage devices 120 (e.g., the first storage device 120-1 to the n^{th} storage device 120-n) may be configured as an SSD.

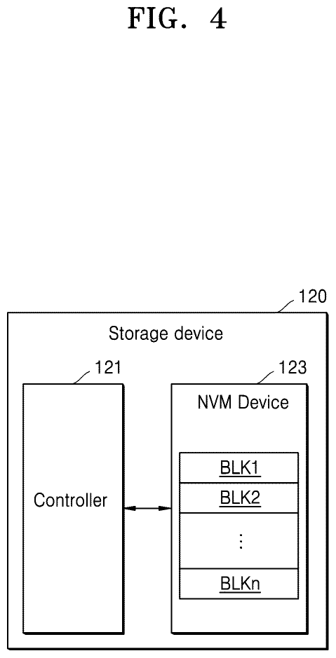

The storage device 120 may be manufactured in one of various types of packages. For example, the storage device 120 may be manufactured in one of various types of packages, such as a package on package (POP), a system in package (SIP), a system on chip (SOC), a multi-chip package (MCP), a chip on board (COB), a wafer-level fabricated package (WFP), and a wafer-level stack package (WSP). The description of the configuration of the storage device 120 is given below with reference to FIG. 4.

FIG. 4 is a block diagram of an example of a storage device.

Referring to FIG. 4, the storage device 120 may include a controller 121 and a non-volatile memory (NVM) device 123. The controller 121 may receive the command from the host 200 through the device controller 110 of the storage box 100. The controller 121 may control the NVM device 123 to write data to the NVM device 123 in response to a write request command from the host 200 or control the NVN device 123 to read data stored in the NVM device 123 in response to a read request command from the host 200.

The NVM device 123 may include a plurality of memory cells. For example, the plurality of memory cells may include flash memory cells. In some implementations, the plurality of memory cells may include NAND flash memory cells. However, the present disclosure is not limited thereto. In some implementations, the plurality of memory cells may include resistive memory cells, such as resistive RAM (ReRAM), phase-change RAM (PRAM), or magnetic RAM (MRAM).

The memory cells may each include a single-level cell (SLC) that stores one bit of data, a multi-level cell (MLC) that stores two bits of data, a triple-level cell (TLC) that stores three bits of data, or a quad-level cell (QLC) that may store four bits of data.

The NVM device 123 may include a plurality of memory blocks, for example, first to n^{th} blocks BLK1 to BLKn, where n is an integer of 2 or greater. Each memory block may include a plurality of memory cells. Each memory block may include a plurality of pages. In some implementations, the page may include a unit that stores data in the NVM device 123 or reads data stored in the NVM device 123. The memory block may include a unit that erases data.

The controller 121 may receive an authentication value of the storage device from the device controller 110 of the storage box 100 in advance. The controller 121 may store the received authentication value of the storage device in the NVM device 123. When the device controller 110 later receives an authentication command for device authentication from the host 200, the controller 121 may transmit the stored authentication value of the storage device to the device controller 110 in response to the authentication request from the device controller 110.

FIG. 5 is a block diagram of an example of a storage box.

Referring to FIG. 5, the device controller 110 may include a random number generator 111, an authentication value generation circuit 113, and an authentication verification circuit 115. In FIG. 5, it is assumed that the first storage device (Storage Device #1), the third storage device (Storage Device #3), and the seventh storage device (Storage Device #7) are currently in operation in the storage box 100.

In some implementations, the random number generator 111 may generate a plurality of random numbers as a plurality of shared keys in response to receiving a control signal (e.g., a shared key generation signal) from the authentication value generation circuit 113. The plurality of random numbers may include a plurality of shared keys which are shared between the device controller 110 and the plurality of storage devices 120 included in the storage box 100. The random number generator 111 may transmit the generated plurality of shared keys (i.e., the plurality of random numbers) to the authentication value generation circuit 113.

In some implementations, the authentication value generation circuit 113 may generate, based on the plurality of shared keys received from the random number generator 111 and a device index of a storage device, a plurality of authentication values corresponding to the plurality of storage devices 120, respectively. In some implementations, the authentication value generation circuit 113 may generate the plurality of authentication values based on the following Equation 1.

$$V \# i = S + b * i + a * {i}^{2} \qquad [ Equation 1 ]$$

wherein V #i may refer to an authentication value of an i^{th} storage device (Storage Device #i), and i may refer to a device index of the storage device. For example, hereinafter, it is assumed that the plurality of shared keys (S, a, b) are indicated as (S, a, b)=(10, 1, 1). The authentication value (e.g., the first authentication value (V #1)) of the first storage device 121-1 (Storage Device #1) may be “12” according to the following Equation 1 (e.g., V #1=10+1*1+1*1²). The authentication value (e.g., the second authentication value (V #2)) of the second storage device 121-2 (Storage Device #2) may be “16” according to the following Equation 1 (e.g., V #2=10+1*2+1*2²). The authentication value (e.g., the third authentication value (V #3)) of the third storage device 121-3 (Storage Device #3) may be “22” according to the following Equation 1 (e.g., V #3=10+1*3+1*3²). The authentication value (e.g., the seventh authentication value (V #7)) of the seventh storage device 121-7 (Storage Device #7) may be “66” according to the following Equation 1 (e.g., V #7=10+1*7+1*7²).

In some implementations, the authentication value generation circuit 113 may transmit the generated authentication value for each storage device to the corresponding storage device. For example, the first authentication value (V #1) corresponding to the first storage device 121-1 (Storage Device #1) may be transmitted to the first storage device 121-1 (Storage Device #1), the second authentication value (V #2) corresponding to the second storage device 121-2 (Storage device #2) may be transmitted to the second storage device 121-2 (Storage Device #2), the third authentication value (V #3) corresponding to the third storage device 121-3 (Storage Device #3) may be transmitted to the third storage device 121-3 (Storage Device #3), the fourth authentication value (V #4) corresponding to the fourth storage device 121-4 (Storage Device #4) may be transmitted to the fourth storage device 121-4 (Storage Device #4), the fifth authentication value (V #5) corresponding to the fifth storage device 121-5 (Storage Device #5) may be transmitted to the fifth storage device 121-5 (Storage Device #5), the sixth authentication value (V #6) corresponding to the sixth storage device 121-6 (Storage Device #6) may be transmitted to the sixth storage device 121-6 (Storage Device #6), the seventh authentication value (V #7) corresponding to the seventh storage device 121-7 (Storage Device #7) may be transmitted to the seventh storage device 121-7 (Storage Device #7), and the eighth authentication value (V #8) corresponding to the eighth storage device 121-8 (Storage Device #8) may be transmitted to the eighth storage device 121-8 (Storage Device #8).

In some implementations, in response to receiving an authentication command requesting authentication for the storage device from the host 200, the authentication verification circuit 115 may identify target storage devices corresponding to the authentication command and group the identified target storage devices into a target storage group. For example, upon receiving the authentication command that includes an authentication request for currently operating storage devices from the host 200, the authentication verification circuit 115 may group the first storage device (Storage Device #1), the third storage device (Storage Device #3), and the seventh storage device (Storage Device #7) into a target storage group.

In some implementations, the authentication verification circuit 115 may transmit an authentication request (e.g., Challenge) to the target storage devices included in the target storage group and receive an authentication value of the target storage devices from the target storage devices as a response (e.g., Response) thereto. For example, the authentication verification circuit 115 may transmit the authentication request (e.g., Challenge) to the first storage device (Storage Device #1), the third storage device (Storage Device #3), and the seventh storage device (Storage Device #7) included in the target storage group. The authentication verification circuit 115 may receive the first authentication value (V #1) (e.g., “12”), which is an authentication value of the first storage device (Storage Device #1), from the first storage device (Storage Device #1), receive the third authentication value (V #3) (e.g., “22”), which is an authentication value of the third storage device (Storage Device #3), from the third storage device (Storage Device #3), and receive the seventh authentication value (V #7) (e.g., “66”), which is an authentication value of the seventh storage device (Storage Device #7), from the seventh storage device (Storage Device #7).

In some implementations, the authentication verification circuit 115 may verify the authentication for the target storage group based on the received authentication values of the target storage devices. That is, the authentication verification circuit 115 may calculate the estimated shared keys (S′, a′, and b′) of the target storage group based on the authentication values of the target storage devices (and the device index of the storage device) and compare the pre-stored shared keys (S, a, b) with the estimated shared keys (S′, a′, b′). The authentication verification circuit 115 may verify the authentication for the target storage group based on the comparison result. For example, the authentication verification circuit 115 may calculate the estimated shared keys (S′, a′, b′) by using Equation 2 to Equation 4 (i.e., simultaneous first-order equations) based on the first authentication value (V #1) (e.g., 12), the third authentication value (V #3) (e.g., 22), and the seventh authentication value (V #7) (e. g., 66).

$${S}^{′} + {b}^{′} * 1 + {a}^{′} * {1}^{2} = 12 \qquad [ Equation 2 ]$$

$${S}^{′} + {b}^{′} * 3 + {a}^{′} * {3}^{2} = 22 \qquad [ Equation 3 ]$$

$${S}^{′} + {b}^{′} * 7 + {a}^{′} * {7}^{2} = 66 \qquad [ Equation 4 ]$$

The authentication verification circuit 115 may calculate the estimated shared keys (e.g., (S′, a′, b′)=(10, 1, 1)) of the target storage group by using Equation 2 to Equation 4 (i.e., simultaneous first order equations) and verify the authentication for the target storage group based on the comparison result between the pre-stored shared keys and the estimated shared keys. The authentication verification circuit 115 may transmit an authentication success message for the target storage group to the host 200 when all of the pre-stored shared keys (e.g., (S, a, b)=(10, 1, 1)) match the estimated shared keys (e.g., (S′, a′, b′)), i.e., S=S′, a=a′, and b=b′. The authentication verification circuit 115 may transmit an authentication fail message for the target storage group to the host 200 when one of the pre-stored shared keys (e.g., (S, a, b)=(10, 1, 1)) does not match the estimated shared keys.

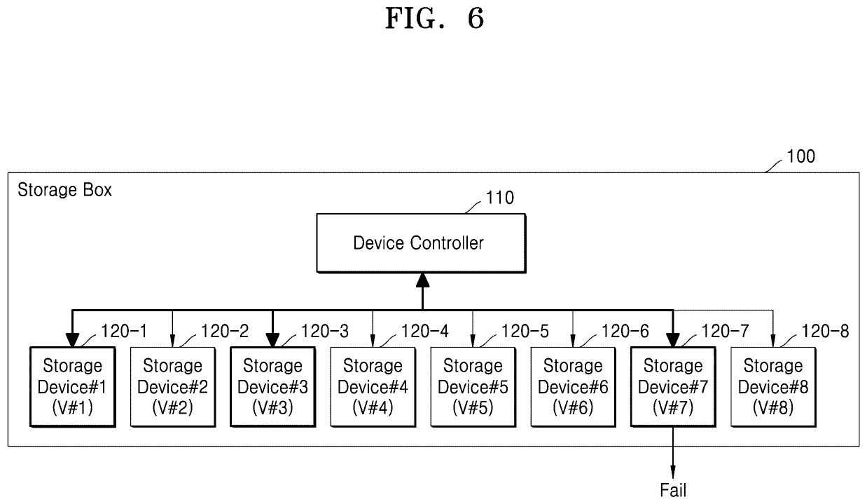

In some implementations, when the authentication for the target storage group fails, the authentication verification circuit 115 may perform an additional operation to identify the target storage device (i.e., forged/modulated storage device) that caused the authentication failure of the target storage group. The detailed description thereof may be given below with reference to FIG. 6.

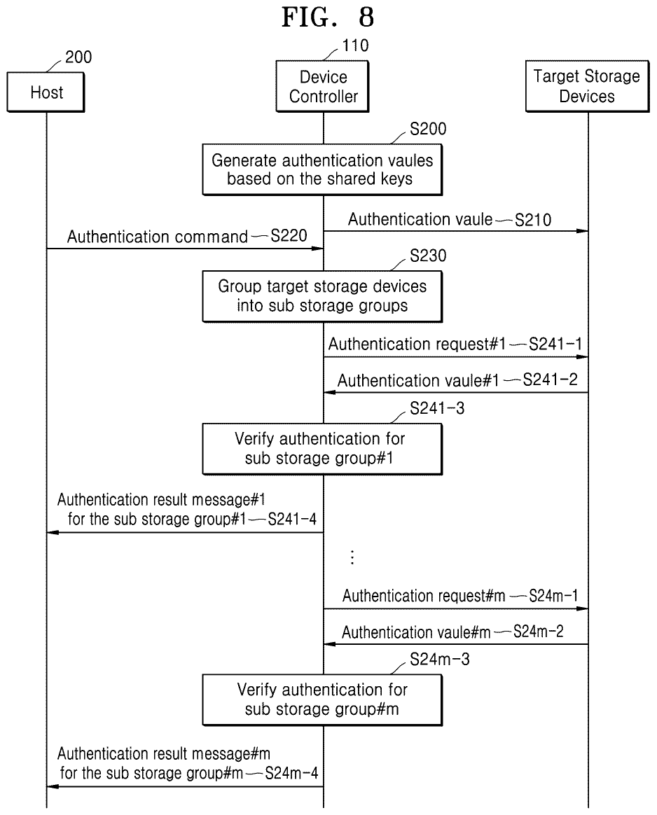

In some implementations, the device controller 110 may group the target storage devices into at least two or more sub-storage groups. The device controller 110 may verify authentication for each of the sub-storage groups and transmit a message on the authentication result of each of the sub-storage groups to the host 200. The detailed description thereof may be given below with reference to FIG. 8.

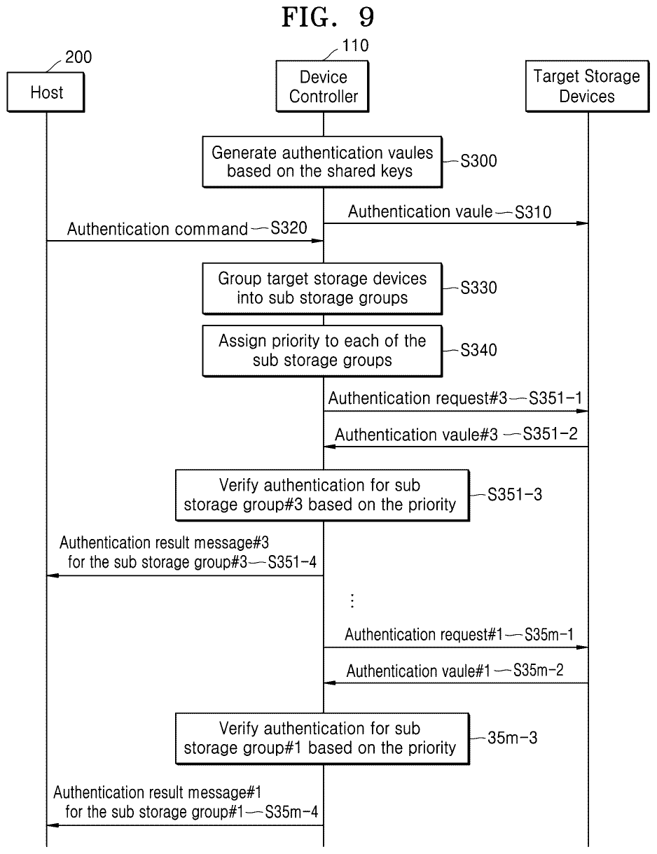

In some implementations, the device controller 110 may group the target storage devices into at least two or more sub-storage groups. The device controller 110 may assign priorities to the sub-storage groups according to predetermined criteria and verify authentication for the sub-storage groups according to the priorities. The device controller 110 may transmit a message on the authentication result of each of the sub-storage groups to the host 200 according to the priorities. The predetermined criteria may be determined based on at least one of throughput for each sub-storage group, priority of processing tasks, and user selection. The detailed description thereof may be given below with reference to FIG. 9.

As described above, the device controller 110 of the storage box 100 may unify the management of authentication values for the plurality of storage devices 120 and the verification of the authentication for the plurality of storage devices 120, thereby maximizing the efficiency of the authentication process for the plurality of the storage devices.

In addition, the device controller 110 of the storage box 100 may perform authentication simultaneously on the plurality of storage devices for each storage group by using authentication values of the storage devices generated based on the shared key (e.g., S, a, b). When a target storage device to be authenticated is changed during the authentication process (e.g., when an operating storage device is changed during the authentication process for currently operating storage devices), the device controller 110 may perform authentication at high speed on the changed target storage device.

For convenience of description with reference to FIG. 5, the plurality of storage devices 120 included in the storage box 100 are shown as the first storage device 120-1 (Storage Device #1) to the eighth storage device 120-8 (Storage Device #8) but are not limited thereto. The storage box 100 may include various numbers of storage devices 120.

FIG. 6 is a diagram illustrating an example of an operation of a device controller.

More specifically, FIG. 6 is a diagram illustrating an operation of the device controller 110 (e.g., the authentication verification circuit 115) for identifying a target storage device (i.e., the forged/modulated storage device) of the target storage group which caused an authentication failure when authentication for the target storage group has failed. The target storage group in FIG. 6 includes a first storage device (Storage Device #1), a third storage device (Storage Device #3), and a seventh storage device (Storage Device #7), where it is assumed that the seventh storage device (Storage Device #7) is a forged/modulated storage device.

Referring to FIG. 6, when the authentication for the target storage group has failed, the authentication verification circuit 115 may identify the storage device (i.e., the forged/modulated storage device) that caused the authentication failure among the target storage devices in the target storage group based on a verified authentication value which is pre-stored in the authentication verification circuit 115.

In some implementations, the authentication verification circuit 115 may obtain estimated shared keys of the target storage group based on the verified authentication value and at least two of the first authentication value (V #1) of the first storage device (Storage Device #1), the third authentication value (V #3) of the third storage device (Storage Device #3), and the seventh authentication value (V #7) of the seventh storage device (Storage Device #7) and may identify the forged/modulated storage device according to whether the authentication has been successful based on the obtained estimated shared keys. The authentication verification circuit 115 may determine whether the authentication has been successful according to the method of verifying the authentication for the target storage group based on the estimated shared keys in FIG. 5.

For example, the authentication verification circuit 115 may obtain the estimated shared keys (S1, a1, b1) of the target storage group based on the first authentication value (V #1), the third authentication value (V #3), and the verified authentication value (k). The authentication verification circuit 115 may obtain the estimated shared keys (S2, a2, b2) of the target storage group based on the third authentication value (V #3), the seventh authentication value (V #7), and the verified authentication value (k). The authentication verification circuit 115 may obtain the estimated shared keys (S3, a3, b3) of the target storage group based on the first authentication value (V #1), the seventh authentication value (V #7), and the verified authentication value (k). In this case, when the estimated shared keys (S1, a1, b1) match the pre-stored shared keys (S, a, b) but the estimated shared key (S2, a2, b2) and the estimated shared keys (S3, a3, b3) do not match the pre-stored shared key (S, a, b), the authentication verification circuit 115 may identify the seventh storage device (Storage Device #7) as a forged/modulated storage device.

As described above, the authentication verification circuit 115 (or the device controller 110) of the storage box 100 may authenticate each storage group at high speed. In addition, when authentication for each storage group has failed, the authentication verification circuit 115 may identify a storage device (i.e., the forged/modulated storage device) that caused authentication failure, thereby enhancing the device security.

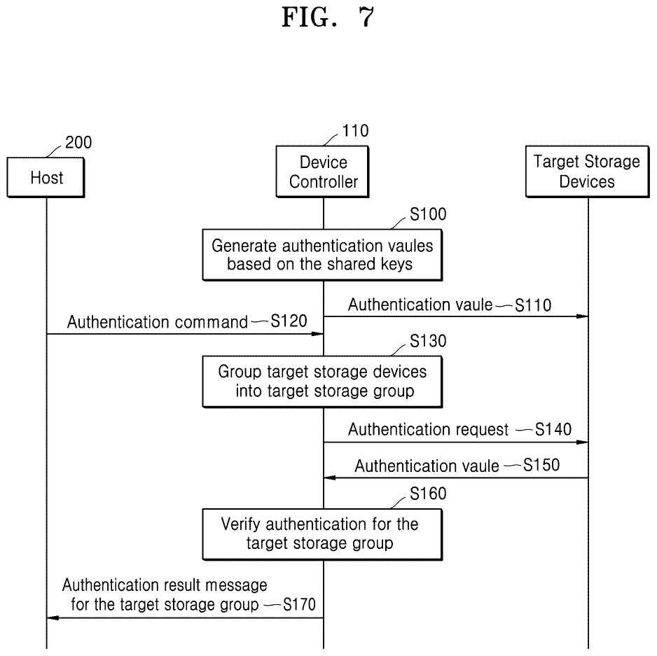

FIG. 7 is a flowchart of an example of a device authentication method for each storage group.

More specifically, FIG. 7 is a diagram illustrating an authentication method for each target storage group. The target storage group may refer to a storage group including all of a plurality of storage devices (i.e., target storage devices) for which authentication has been requested by the host 200.

Referring to FIG. 7, the device authentication method for each target storage group may include operations S100 to S170. The description with reference to FIG. 7 that overlaps with the description with reference to FIGS. 1 to 6 may be replaced with the description with reference to FIGS. 1 to 6.

In operation S100, the device controller 110 of the storage box 100 may generate authentication values of each of the storage devices based on the shared keys. For example, the device controller 110 may generate, based on the shared keys and the device index of the storage device, a plurality of authentication values corresponding to the plurality of storage devices, respectively.

In operation S110, the device controller 110 may transmit/distribute the generated plurality of authentication values to the storage devices corresponding to the plurality of authentication values, respectively.

In operation S120, the host 200 may transmit an authentication command to the device controller 110. The host 200 may directly indicate the device index of the storage devices (i.e., target storage devices) requesting authentication through the authentication command or indirectly indicate the storage devices (e.g., target storage device) requesting authentication through the authentication command (e.g., the authentication command requesting authentication for currently operating storage devices).

In operation S130, the device controller 110 may identify the target storage devices corresponding to the authentication command in response to receiving the authentication command from the host 200 and may group the identified target storage devices into a target storage group.

In operation S140, the device controller 110 may transmit an authentication request (e.g., Challenge) to the target storage devices included in the target storage group.

In operation S150, the target storage devices may transmit an authentication value (e.g., Response) of each of the target storage devices to the device controller 110 in response to the authentication request (e.g., Challenge).

In operation S160, the device controller 110 may verify the authentication for the target storage group based on the authentication values of the target storage devices. In operation S170, the device controller 110 may transmit an authentication result message for the target storage group to the host 200. For example, the device controller 110 may obtain estimated shared keys of the target storage group based on the authentication values of the target storage devices. The device controller 110 may compare the pre-stored shared keys with the obtained estimated shared keys and may verify the authentication for the target storage group based on the comparison result. The device controller 110 may transmit an authentication success message for the target storage group to the host 200 when all of the pre-stored shared keys match the estimated shared keys. The device controller 110 may transmit an authentication fail message for the target storage group to the host 200 when one of the pre-stored shared keys does not match the estimated shared keys.

FIG. 8 is a flowchart of an example of a device authentication method for each storage group.

More specifically, FIG. 8 is a diagram illustrating an authentication method for a plurality of storage devices on a sub-storage group basis. The sub-storage group may refer to a storage group including at least some of the plurality of storage devices (i.e., target storage devices) for which authentication has been requested by the host 200.

Referring to FIG. 8, a device authentication method for each sub-storage group may include operations S200 to S24m-4. The description with reference to FIG. 8 that overlaps with the description with reference to FIGS. 1 to 7 may be replaced with the description with reference to FIGS. 1 to 7. The description of the operations S200 to S220 with reference to FIG. 8 that overlaps with the description of the operations S100 to S120 with reference to FIG. 7 may be replaced with the description with reference to FIG. 7.

In operation S230, the device controller 110 of the storage box 100 may identify the target storage devices corresponding to the authentication command in response to receiving the authentication command from the host 200 and may group the identified target storage devices into a plurality of sub-storage groups. For example, when receiving the authentication command for n target storage devices from the host 200, the device controller 110 may generate the plurality of sub-storage groups by grouping the target storage devices by m (where m is a positive integer less than n) according to the operation environment of the storage box 100.

In operation S241-1, the device controller 110 may transmit an authentication request (e.g., Challenge) to the target storage devices included in the first sub-storage group.

In operation S241-2, the target storage devices included in the first sub-storage group may transmit an authentication value (e.g., Response) of each of the target storage devices to the device controller 110 in response to the authentication request (e.g., Challenge).

In operation S241-3, the device controller 110 may verify the authentication for the first sub-storage group based on the authentication values of the target storage devices included in the first sub-storage group (sub storage group #1). In operation S241-4, the device controller 110 may transmit an authentication result message for the first sub-storage group to the host 200. For example, the device controller 110 may obtain the estimated shared keys of the first sub-storage group based on the authentication values of the target storage devices included in the first sub-storage group. The device controller 110 may compare the pre-stored shared keys with the obtained estimated shared keys and may verify authentication for the first sub-storage group based on the comparison result. The device controller 110 may transmit an authentication success message for the first sub-storage group to the host 200 when all of the pre-stored shared keys match the estimated shared keys. The device controller 110 may transmit an authentication fail message for the first sub-storage group to the host 200 when one of the pre-stored shared keys does not match the estimated shared keys. Although not shown in FIG. 8 for convenience of description, the device controller 110 may sequentially verify authentication for the second sub-storage group (sub storage group #2) to the m-1th sub-storage group (sub storage group #m-1) in the same manner as the authentication operation (e.g., operations S241-1 to S241-4) of the first sub-storage group described above.

In operation S24m-1, the device controller 110 may transmit an authentication request (e.g., Challenge) to the target storage devices included in the mth sub-storage group (sub storage group #m).

In operation S24m-2, the target storage devices included in the mth sub-storage group may transmit an authentication value (e.g., Response) of each of the target storage devices to the device controller 110 in response to the authentication request (e.g., Challenge).

In operation S24m-3, the device controller 110 may verify the authentication for the mth sub-storage group based on the authentication values of the target storage devices included in the mth sub-storage group. In operation S24m-4, the device controller 110 may transmit an authentication result message for the mth sub-storage group to the host 200. For example, the device controller 110 may obtain the estimated shared keys of the mth sub-storage group based on the authentication values of the target storage devices included in the mth sub-storage group. The device controller 110 may compare the pre-stored shared keys with the obtained estimated shared keys and may verify the authentication for the mth sub-storage group based on the comparison result. The device controller 110 may transmit an authentication success message for the mth sub-storage group to the host 200 when all of the pre-stored shared keys match the estimated shared keys. The device controller 110 may transmit an authentication fail message for the mth sub-storage group to the host 200 when one of the pre-stored shared keys does not match the estimated shared keys.

As described above, the device controller 110 of the storage box 100 may not limit each storage group to the number of storage devices requested by the host 200 and may perform the authentication for each sub-storage group including various numbers of storage devices.

FIG. 9 is a flowchart of an example of a device authentication method for each storage group.

More specifically, FIG. 9 is a diagram illustrating an authentication method for a plurality of storage devices on a sub-storage group basis. The sub-storage group may refer to a storage group including at least some of the plurality of storage devices (i.e., target storage devices) for which authentication has been requested by the host 200.

Referring to FIG. 9, the device authentication method for each sub-storage group may include operations S300 to S35m-4. The description with reference to FIG. 9 that overlaps with the description with reference to FIGS. 1 to 8 may be replaced with the description with reference to FIGS. 1 to 8. The description of operations S300 to S320 with reference to FIG. 9 that overlaps with the description of operations S100 to S120 with reference to FIG. 7 may be replaced with the description with reference to FIG. 7. The description of operation S330 with reference to FIG. 9 that overlaps with the description of the operation S230 with reference to FIG. 8 may be replaced with the description with reference to FIG. 8.

In operation S340, the device controller 110 of the storage box 100 may assign priority to a plurality of sub-storage groups according to predetermined criteria. The predetermined criteria may be determined based on at least one of throughput for each sub-storage group, a priority of processing tasks, and user selection. It is assumed that the priority of the third sub-storage group (sub storage group #3) among the plurality of sub-storage groups is the highest and the priority of the first sub-storage group (sub storage group #1) is the lowest. For example, the device controller 110 may verify authentication for the third sub-storage group with the highest priority first and verify authentication for the first sub-storage group with the lowest priority last.

In operation S351-1, the device controller 110 may transmit an authentication request (e.g., Challenge) to the target storage devices included in the third sub-storage group (assuming that the priority of the third sub-storage group is the highest among the plurality of storage devices in operation S340).

In operation S351-2, the target storage devices included in the third sub-storage group may transmit an authentication value (e.g., Response) of each of the target storage devices to the device controller 110 in response to the authentication request (e.g., Challenge).

In operation S351-3, the device controller 110 may verify the authentication for the third sub-storage group based on the authentication values of the target storage devices included in the third sub-storage group (sub-storage group #3) based on the priority in operation S340. In operation S351-4, the device controller 110 may transmit an authentication result message for the third sub-storage group to the host 200. For example, the device controller 110 may obtain the estimated shared keys of the third sub-storage group based on the authentication values of the target storage devices included in the third sub-storage group. The device controller 110 may compare the pre-stored shared keys with the obtained estimated shared keys and may verify the authentication for the third sub-storage group based on the comparison result. The device controller 110 may transmit an authentication success message for the third sub-storage group to the host 200 when all of the pre-stored shared keys match the estimated shared keys. The device controller 110 may transmit an authentication fail message for the third sub-storage group to the host 200 when one of the pre-stored shared keys does not match the estimated shared keys. Although not shown in FIG. 9 for convenience of description, the device controller 110 may sequentially verify the authentication for the other sub-storage groups according to the priority in the same manner as the authentication operation (e.g., operations S351-1 to S351-4) of the third sub-storage group described above.

In operation S35m-1, the device controller 110 may transmit an authentication request (e.g., Challenge) to the target storage devices included in the first sub-storage group (sub storage group #1) (assuming that the priority of the first sub storage group is the lowest among the plurality of storage devices in operation S340).

In operation S35m-2, the target storage devices included in the first sub-storage group may transmit an authentication value (e.g., Response) of each of the target storage devices to the device controller 110 in response to the authentication request (e.g., Challenge).

In operation S35m-3, the device controller 110 may verify the authentication for the first sub-storage group based on the authentication values of the target storage devices included in the first sub-storage group based on the priority in operation S340. In operation S35m-4, the device controller 110 may transmit an authentication result message for the first sub-storage group to the host 200. For example, the device controller 110 may obtain the estimated shared keys of the first sub-storage group based on the authentication values of the target storage devices included in the first sub-storage group. The device controller 110 may compare the pre-stored shared keys with the obtained estimated shared keys and may verify the authentication for the first sub-storage group based on the comparison result. The device controller 110 may transmit an authentication success message for the first sub-storage group to the host 200 when all of the pre-stored shared keys match the estimated shared keys. The device controller 110 may transmit an authentication fail message for the first sub-storage group to the host 200 when one of the pre-stored shared keys does not match the estimated shared keys.

As described above, the device controller 110 of the storage box 100 may perform authentication for each sub-storage group including various numbers of storage devices according to the priority for each sub-storage group.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been particularly shown and described with reference to implementations thereof, it will be understood that various changes in form and details may be made therein without departing from the spirit and scope of the following claims.

What is claimed is:

1. A device controller comprising:
an authentication value generation circuit configured to
generate a plurality of authentication values based on a plurality of shared keys, and
transmit the plurality of authentication values to a plurality of storage devices; and
an authentication verification circuit configured to
identify, based on receiving an authentication command from a host, a plurality of target storage devices corresponding to the authentication command,
group the plurality of target storage devices into a target storage group, and
verify authentication for the target storage group based on a plurality of authentication values of the plurality of target storage devices.

2. The device controller of claim 1, wherein the device controller comprises a random number generator, wherein the random number generator is configured to
generate, based on receiving a shared key generation signal from the authentication value generation circuit, a plurality of random numbers as the plurality of shared keys, and
transmit the plurality of shared keys to the authentication value generation circuit.

3. The device controller of claim 1, wherein the authentication value generation circuit is configured to
generate, based on the plurality of shared keys and a device index of a storage device, the plurality of authentication values, the plurality of authentication values corresponding to the plurality of storage devices, respectively, and
transmit the plurality of authentication values to the plurality of storage devices, respectively.

4. The device controller of claim 1, wherein the authentication verification circuit is configured to
obtain a plurality of estimated shared keys of the target storage group based on a plurality of authentication values of the plurality of target storage devices,
compare the plurality of shared keys with the plurality of estimated shared keys to obtain a comparison result, the plurality of shared keys being pre-stored in the authentication verification circuit, and
verify the authentication for the target storage group based on the comparison result.

5. The device controller of claim 4, wherein the authentication verification circuit is configured to verify the authentication for the target storage group based on the comparison result, by:
transmitting an authentication success message for the target storage group to the host based on all of the plurality of shared keys matching the plurality of estimated shared keys, and
transmitting an authentication fail message for the target storage group to the host based on a shared key of the plurality of shared keys not matching the plurality of estimated shared keys.

6. The device controller of claim 1, wherein the authentication verification circuit is configured to
group the plurality of target storage devices into a plurality of sub-storage groups,
verify authentication for each sub-storage group of the plurality of sub-storage groups, and
transmit an authentication result message for each sub-storage group of the plurality of sub-storage groups to the host.

7. The device controller of claim 6, wherein the authentication verification circuit is configured to
assign priority to the plurality of sub-storage groups according to a plurality of predetermined criteria, and
verify the authentication for the plurality of sub-storage groups according to the priority, wherein the plurality of predetermined criteria are determined based on at least one of throughput for each sub-storage group, priority of a plurality of processing tasks, and user selection.

8. The device controller of claim 1, wherein the authentication verification circuit is configured to, based on the authentication for the target storage group being failed,
identify a modulated storage device among the plurality of target storage devices in the target storage group based on a verified authentication value, the verified authentication value being pre-stored in the authentication verification circuit.

9. A method of operating a device controller, the method comprising:
generating a plurality of authentication values based on a plurality of shared keys;
transmitting the plurality of authentication values to a plurality of storage devices;
based on receiving an authentication command from a host, identifying a plurality of target storage devices corresponding to the authentication command;
grouping the plurality of target storage devices into a target storage group;
verifying authentication for the target storage group based on a plurality of authentication values of the plurality of target storage devices received from the plurality of target storage devices; and
transmitting an authentication result message for the target storage group to the host.

10. The method of claim 9, wherein the method comprises generating a plurality of random numbers as the plurality of shared keys based on a shared key generation signal.

11. The method of claim 9, wherein generating the plurality of authentication values based on the plurality of shared keys and transmitting the plurality of authentication values to the plurality of storage devices comprises
generating, based on the plurality of shared keys and a device index of a storage device, the plurality of authentication values, the plurality of authentication values corresponding to the plurality of storage devices, respectively, and
transmitting the plurality of authentication values to the plurality of storage devices corresponding to the plurality of authentication values, respectively.

12. The method of claim 9, wherein verifying the authentication for the target storage group comprises:
obtaining a plurality of estimated shared keys of the target storage group based on the plurality of authentication values of the plurality of target storage devices;
comparing a plurality of pre-stored shared keys with the plurality of estimated shared keys to obtain a comparison result; and
verifying the authentication for the target storage group based on the comparison result.

13. The method of claim 12, wherein verifying the authentication for the target storage group based on the comparison result comprises
transmitting an authentication success message for the target storage group to the host based on all of the plurality of pre-stored shared keys matching the plurality of estimated shared keys, and
transmitting an authentication fail message for the target storage group to the host based on a pre-stored shared key of the plurality of pre-stored shared keys not matching the plurality of estimated shared keys.

14. The method of claim 9, wherein the method comprises:
grouping the plurality of target storage devices into a plurality of sub-storage groups;
verifying authentication for each sub-storage group of the plurality of sub-storage groups; and
transmitting an authentication result message for each sub-storage group of the plurality of sub-storage groups to the host.

15. The method of claim 14, wherein verifying the authentication for each sub-storage group of the plurality of sub-storage groups comprises
assigning priority to the plurality of sub-storage groups based on a plurality of predetermined criteria, and
verifying the authentication for the plurality of sub-storage groups according to the priority, wherein the plurality of predetermined criteria are determined based on at least one of throughput for each sub-storage group, priority of a plurality of processing tasks, and user selection.

16. The method of claim 14, wherein the method comprises:
based on the authentication for the target storage group being failed, identifying a modulated storage device among the plurality of target storage devices in the target storage group based on a plurality of pre-stored verified authentication values.

17. A storage system comprising:
a host; and
a storage box comprising a device controller and a plurality of storage devices, wherein the device controller of the storage box is configured to
generate a plurality of authentication values based on a plurality of shared keys between the device controller and the plurality of storage devices;
distribute the plurality of authentication values to the plurality of storage devices, respectively;
based on receiving an authentication command from the host, group a plurality of target storage devices into a target storage group, the plurality of target storage devices corresponding to the authentication command;
receive a plurality of authentication values of the plurality of target storage devices from the plurality of target storage devices;
verify authentication for the target storage group based on the plurality of authentication values of the plurality of target storage devices; and
transmit an authentication result of the target storage group to the host,
wherein the plurality of authentication values are generated based on the plurality of shared keys.

18. The storage system of claim 17, wherein the device controller is configured to
generate, based on the plurality of shared keys and a device index of a storage device, the plurality of authentication values, the plurality of authentication values corresponding to the plurality of storage devices, respectively.

19. The storage system of claim 17, wherein the device controller is configured to verify the authentication for the target storage group, by:
obtaining a plurality of estimated shared keys of the target storage group based on the plurality of authentication values of the plurality of target storage devices, and
generating an authentication result of the target storage group based on a comparison result between the plurality of shared keys and the plurality of estimated shared keys.

20. The storage system of claim 17, wherein the device controller is configured to
group the plurality of target storage devices into a plurality of sub-storage groups;
verify authentication for each sub-storage group of the plurality of sub-storage groups; and
transmit an authentication result message for each sub-storage group of the plurality of sub-storage groups to the host.
